(19) United States
(12) Patent Application Publication
(10) Pub. No.: US 2021/0360410 A1
(43) Pub. Date: Nov. 18, 2021

(54) IDENTIFICATION AND VERIFICATION OF ASSOCIATED DEVICES USING AUDIO TRANSMISSIONS

(71) Applicant: LISNR, Cincinnati, OH (US)

(72) Inventors: Jacob Engwerda, San Francisco, CA (US); Jon Vogel, Boston, MA (US); Elizabeth Faucher De Corn, Berkeley, CA (US); Srivathsan Narasimhan, Saratoga, CA (US)

(21) Appl. No.: 17/322,313

(22) Filed: May 17, 2021

Related U.S. Application Data
(60) Provisional application No. 63/026,382, filed on May 18, 2020.

(51) Int. Cl. H04W 12/55; H04W 12/65; H04L 29/06

(52) U.S. Cl. CPC H04W 12/55; H04L 63/18; H04W 12/65

(57) ABSTRACT

Methods and systems for improved identification and matching of devices are presented. In one embodiment, a method is provided that includes receiving a first audio transmission that contains a first unique identifier. The first audio transmission may be received from a first computing device. It may be determined that the first unique identifier is associated with the first computing device and that the first computing device is associated with a request. At least a portion of the request may be processed.

### CROSS-REFERENCE TO RELATED APPLICATIONS

The present application claims priority to U.S. Provisional Application No. 63/026,382, filed on May 18, 2020, the disclosure of which is incorporated herein by reference for all purposes.

### BACKGROUND

Various software applications enable users to match with other individuals who provide services. For example, the software applications may execute on mobile phones to identify and match users with the individuals providing particular services. To receive these services, it may often be necessary for a user to identify the individual in the real world (e.g., when the individual is near the user).

### SUMMARY

The present disclosure presents new and innovative systems and methods for identifying and matching devices associated with requests. In a first aspect, a method is provided that includes receiving, from a first computing device, a first audio transmission containing a first unique identifier and determining that the first unique identifier is associated with the first computing device. The method may further include determining that the first computing device is associated with a request and processing at least a portion of the first request.

In a second aspect according to the first aspect, the first audio transmission is received at a second computing device.

In a third aspect according to the second aspect, the method further comprises, prior to receiving the first audio transmission, transmitting, from the second computing device, a second audio transmission containing a second unique identifier.

In a fourth aspect according to the third aspect, the first computing device and the second computing device are configured to respectively transmit the first audio transmission and the second audio transmission at least partially at the same time.

In a fifth aspect according to any of the third and fourth aspects, the first audio transmission is transmitted on a first audio channel and the second audio transmission is transmitted on a second audio channel different from the first audio channel.

In a sixth aspect according to any of the third through fifth aspects, the first request is associated with transportation of a user using a vehicle. The first computing device may be associated with the user and the second computing device is associated with an operator of the vehicle and/or the first computing device may be associated with the operator of the vehicle and the second computing device is associated with the user.

In a seventh aspect according to the sixth aspect, at least one of the first audio transmission and the second audio transmission is transmitted using speakers of the vehicle.

In an eighth aspect according to any of the sixth and seventh aspects, at least one of the first audio transmission and the second audio transmission is transmitted using a transducer affixed to at least a portion of the vehicle.

In a ninth aspect according to any of the sixth through eighth aspects, at least one of the first audio transmission and the second audio transmission is transmitted using a horn of the vehicle.

In a tenth aspect according to any of the second through ninth aspects, the first request is associated with delivery of a product using a vehicle. The first computing device may be associated with a provider of the product and the second computing device is associated with an operator of the vehicle and/or the first computing device may be associated with the operator of the vehicle and the second computing device is associated with the provider of the product.

In an eleventh aspect according to any of the second through tenth aspects, the first computing device transmits the first audio transmission in response to at least one of (i) detecting that a location of the first computing entered a geofence associated with the first request, (ii) detecting an audio signal transmitted by the second computing device, and (iii) detecting an audio signal transmitted by a third computing device associated with the first request.

In a twelfth aspect according to any of the first through eleventh aspects, receiving the first audio transmission further comprises detecting a predetermined portion of the audio transmission and extracting the first unique identifier from the audio transmission.

In a thirteenth aspect according to any of the first through twelfth aspects, the first unique identifier is a single-use identifier temporarily associated with the first computing device.

In a fourteenth aspect according to any of the first through thirteenth aspects, determining that the unique identifier is associated with the first computing device includes determining that the unique identifier is associated with a user account corresponding to the first computing device.

In a fifteenth aspect, a system is provided that includes a processor and a memory. The memory may store instructions which, when executed by the processor, cause the processor to receive, from a first computing device, a first audio transmission containing a first unique identifier and determine that the first unique identifier is associated with the first computing device. The memory may store further instructions which, when executed by the processor, cause the processor to determine that the first computing device is associated with a request and process at least a portion of the first request.

In a sixteenth aspect according to the fifteenth aspect, the first audio transmission is received at a second computing device containing the processor and the memory.

In a seventeenth aspect according to the sixteenth aspect, the memory stores further instructions which, when executed by the processor prior to receiving the first audio transmission, cause the processor to transmit, from the second computing device, a second audio transmission containing a second unique identifier.

In an eighteenth aspect according to the seventeenth aspect, the first computing device and the second computing device are configured to respectively transmit the first audio transmission and the second audio transmission at least partially at the same time.

In a nineteenth aspect according to any of the seventeenth and eighteenth aspects, the first audio transmission is transmitted on a first audio channel and the second audio transmission is transmitted on a second audio channel different from the first audio channel.

In a twentieth aspect according to any of the seventeenth through nineteenth aspects, the first request is associated with transportation of a user using a vehicle. The first computing device may be associated with the user and the second computing device is associated with an operator of the vehicle and/or the first computing device may be associated with the operator of the vehicle and the second computing device is associated with the user.

In a twenty-first aspect according to the twentieth aspect, at least one of the first audio transmission and the second audio transmission is transmitted using speakers of the vehicle.

In a twenty-second aspect according to any of the twentieth and twenty-first aspects, at least one of the first audio transmission and the second audio transmission is transmitted using a transducer affixed to at least a portion of the vehicle.

In a twenty-third aspect according to any of the twentieth through twenty-second aspects, at least one of the first audio transmission and the second audio transmission is transmitted using a horn of the vehicle.

In a twenty-fourth aspect according to any of the sixteenth through twenty-third aspects, the first request is associated with delivery of a product using a vehicle. The first computing device may be associated with a provider of the product and the second computing device is associated with an operator of the vehicle and/or the first computing device may be associated with the operator of the vehicle and the second computing device is associated with the provider of the product.

In a twenty-fifth aspect according to any of the sixteenth through twenty-fourth aspects, the first computing device transmits the first audio transmission in response to at least one of (i) detecting that a location of the first computing entered a geofence associated with the first request, (ii) detecting an audio signal transmitted by the second computing device, and (iii) detecting an audio signal transmitted by a third computing device associated with the first request.

In a twenty-sixth aspect according to any of the fifteenth through twenty-fifth aspects, receiving the first audio transmission further comprises detecting a predetermined portion of the audio transmission and extracting the first unique identifier from the audio transmission.

In a twenty-seventh aspect according to any of the fifteenth through twenty-sixth aspects, the first unique identifier is a single-use identifier temporarily associated with the first computing device.

In a twenty-eighth aspect according to any of the fifteenth through twenty-seventh aspects, determining that the unique identifier is associated with the first computing device includes determining that the unique identifier is associated with a user account corresponding to the first computing device.

In a twenty-ninth aspect, a non-transitory, computer-readable medium storing instructions which, when executed by a processor, cause the processor to receive, from a first computing device, a first audio transmission containing a first unique identifier and determine that the first unique identifier is associated with the first computing device. The non-transitory, computer-readable medium may store further instructions which, when executed by the processor, cause the processor to determine that the first computing device is associated with a request and process at least a portion of the first request.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system according to an exemplary embodiment of the present disclosure.

FIG. 2 illustrates an audio transmission according to an exemplary embodiment of the present disclosure.

FIG. 3 illustrates a scenario according to an exemplary embodiment of the present disclosure.

FIG. 4 illustrates an audio channel distribution according to an exemplary embodiment of the present disclosure.

FIGS. 5A-5B illustrate audio transmission scenarios according to exemplary embodiments of the present disclosure.

FIG. 6 illustrates a system according to an exemplary embodiment of the present disclosure.

FIG. 7 illustrates a method according to an exemplary embodiment of the present disclosure.

FIG. 8 illustrates a computing system according to an exemplary embodiment of the present disclosure.

### DETAILED DESCRIPTION OF EXAMPLE EMBODIMENTS

Aspects of the present disclosure relate to transmitting and receiving audio transmissions between multiple devices. In certain aspects, a computing device may be associated with a request for service and may receive an audio transmission from a nearby computing device and may verify whether the nearby computing device is associated with the request for service.

Various techniques and systems exist to exchange data between computing devices located near one another without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi® links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired in order to transmit data according to these wireless communication protocols. Such communicative pairing can be cumbersome and slow, reducing the likelihood that users associated with one or both of the computing devices will utilize the protocols to transmit data.

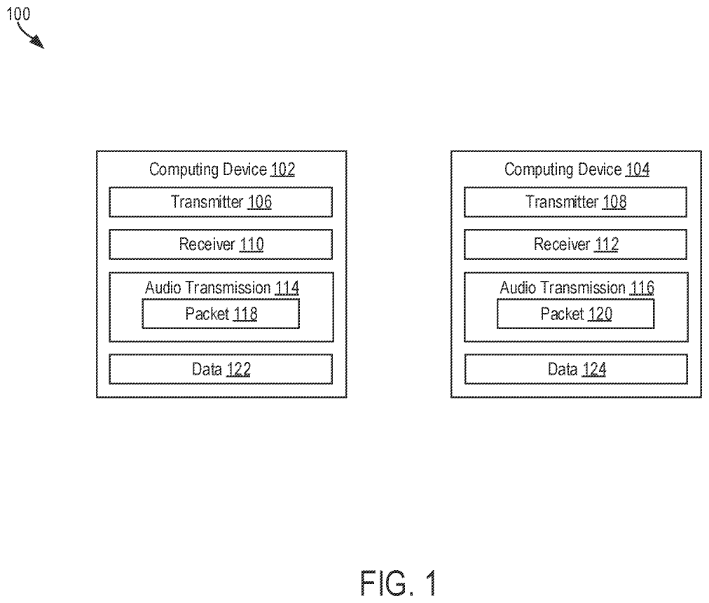

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers or transducers. In certain implementations, the transmitters 106, 108 may be implemented as a speaker built into the computing device 102, 104. For example, one or both of the computing devices may be a smart phone, tablet computer, and/or laptop with a built-in speaker that performs the functions of the transmitter 106, 108. In other implementations, the transmitters 106, 108 may be implemented as a speaker or transducer external to the computing device 102, 104. For example, the transmitters 106, 108 may be implemented as one or more speakers or transducers externally connected to the computing device 102, 104. In still further implementations, transmitters 106, 108 may be communicatively separate from computing devices.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing device 102, 104. For example, one or both of the computing devices may be a smartphone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In certain implementations, the transmitter 106, 108 and receiver 110, 112 may be implemented as a single device connected to the computing device. For example, the transmitter 106, 108 and receiver 110, 112 may be implemented as a single device containing at least one speaker and at least one microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112. In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

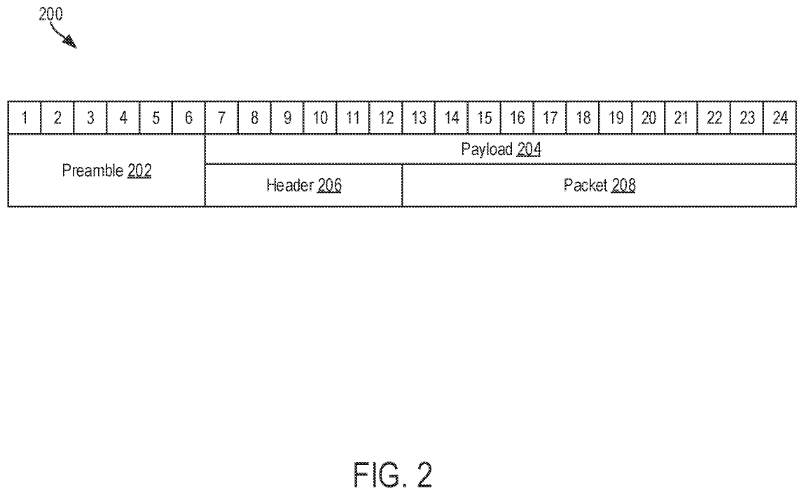

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 2 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated in order to encode information in the audio transmission 200 (e.g., certain frequencies may correspond to certain pieces of information). In another example, the phases of the frequencies may additionally or alternatively be modulated in order to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined symbols produced at predetermined points of time (e.g., by varying one or more of the frequency and the phase in a predetermined manner for the frequencies 1-6). The preamble 202 may be used to identify the audio transmission 200 to a computing device receiving the audio transmission 200. For example, a receiver of the computing device receiving audio transmissions such as the audio transmission 200 may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

The techniques described above may be used to improve the provisioning of services that require users to be located near one another, such as transportation services, delivery services, or other location-based services (e.g., dog walking services). Software platforms exist that allow users to request such services from a computing device, such as a smartphone. These platforms typically require certain users to interact while fulfilling the requested service. For example, when a user requests transportation by a vehicle, the user may interact with a vehicle and/or an operator of a vehicle to enter the vehicle and be transported to their destination. As another example, for delivery services such as food delivery services, a driver of a vehicle may first interact with an employee of a restaurant to pick up food and may later interact with a customer who purchased the food to deliver the food.

In these instances, users are typically required to manually locate and verify one another. For example, when a user is picked up for transportation, they may have to identify a corresponding vehicle by license plate. As another example, when a driver is picking up food for delivery, they may have to request a specific order to receive the proper food. As a further example, users may be verified using one or more biometric scans. These systems may be important for both ensuring that the driver picks up the correct passenger and/or order and for preventing fraudulent claims that users did not receive service (e.g., via a transportation application, via card payment networks). Such systems can be error prone, as users may mistakenly enter the wrong vehicle or drivers may be provided with an incorrect food order. In certain instances, the software platforms may provide a single use passcode (e.g., a 4-8 digit numeric passcode) to one user (e.g., a passenger) that the user may provide to another user (e.g., a driver). The other user may enter the passcode into their computing device to verify whether the passenger who entered the vehicle is the correct user. These solutions can be cumbersome, however, as users have to provide the codes to one another, which can be cumbersome and slow, and which can also introduce errors. Therefore, the software platforms may typically only use such verification systems at busy locations (e.g., at airports or busy restaurants) and/or at busy times). Such restrictions, however, leave many other situations unverified, which can delay the provisioning of services and/or create security risks (e.g., of passengers getting into unauthorized vehicles). Therefore, there exists a need to automatically identify when computing devices associated with the same request for service are located near one another.

One solution to this problem is to use audio transmissions to transmit unique identifiers from one computing device to another. Audio transmissions may typically only be successfully transmitted between computing devices that are located near one another. Therefore, if a computing device receives an audio transmission from another computing device, the two computing devices are likely located near one another. The computing device receiving the audio transmission can then use the received unique identifier to verify whether the computing device that transmitted the audio transmission is associated with the same request for service. For example, the computing device may communicate with a server associated with the software platform to determine whether the unique identifier corresponds to the same request and/or corresponds to a user associated with the same request.

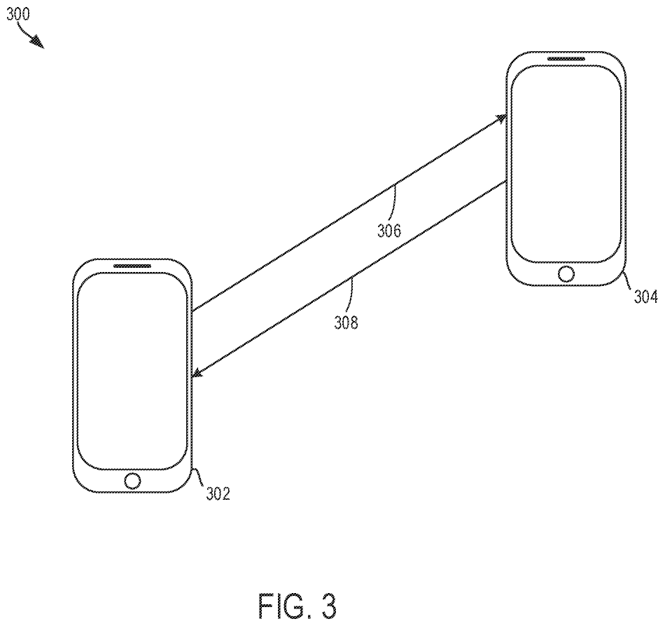

FIG. 3 illustrates a scenario according to an exemplary embodiment of the present disclosure. In the scenario, a computing device 302 transmits an audio transmission 306 to the computing device 304. The computing device 304 also transmits an audio transmission 308 to the computing device 302. As depicted, both of the computing devices 302, 304 are mobile devices (e.g., smartphones). Accordingly, the audio transmissions 306, 308 may be transmitted using speakers of the mobile devices and may be received using microphones of the mobile devices. In certain implementations, the audio transmissions 306, 308 may be transmitted at different times. For example, the computing device 302 may transmit the audio transmission 306 before the computing device 304 transmits the audio transmission 308. In other implementations, the audio transmissions 306, 308 may be transmitted at least partially at the same time. In such instances, the audio transmissions 306, 308 may be transmitted on different channels (e.g., using different carrier frequencies), as explained further below.

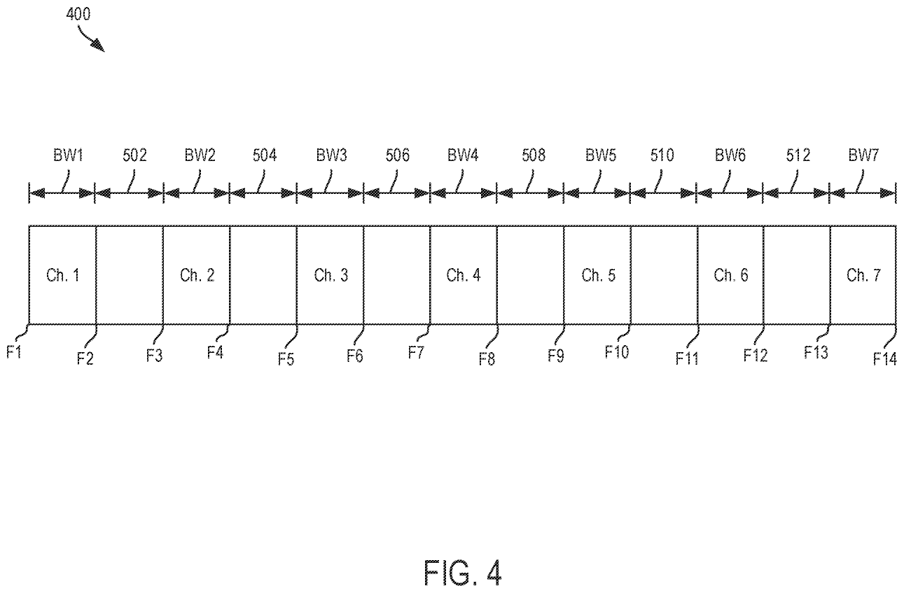

FIG. 4 illustrates an audio channel distribution 400 according to an exemplary embodiment of the present disclosure. The audio channel distribution 400 includes audio channels 1-7 distributed along a frequency spectrum F1-F15. Each audio channel 1-7 has a corresponding bandwidth BW1-7. In particular, audio channel 1 has a bandwidth BW1 spanning from F1 to F2, audio channel 2 has a bandwidth BW2 spanning from F3 to F4, audio channel 3 has a bandwidth BW3 spanning from F5 to F6, audio channel 4 has a bandwidth BW4 spanning from F7 to F8, audio channel 4 has a bandwidth BW5 spanning from F9 to F10, audio channel 6 has a bandwidth BW6 spanning from F11 to F12, and audio channel 7 has a bandwidth BW7 spanning from F13 to F14. The audio channels 1-7 may represent a range of carrier frequencies that can be used to transmit audio transmissions. For example, to transmit an audio transmission according to an audio channel 1, a computing device may utilize a carrier frequency between F1 and F2. In certain implementations, the computing device may use a carrier frequency halfway between F1 and F2. As a specific example, where F1 is 9.5 kHz and F2 is 10.5 kHz, a computing device transmitting an audio transmission using audio channel 1 may preferably utilize a carrier frequency between 9.8 and 10.2 kHz, such as 10 kHz.

The audio channels 1-7 are also separated by frequency bands 402, 404, 406, 408, 410, 412. In particular, frequency band 402 separates audio channels 1 and 2 and spans from frequency F2 to F3, frequency band 404 separates audio channels 2 and 3 and spans from frequency F4 to F5, frequency band 406 separates audio channels 3 and 4 and spans from frequency F6 to F7, frequency band 408 separates audio channels 4 and 5 and spans from frequency F8 to F9, frequency band 410 separates audio channels 5 and 6 and spans from frequency F10 to F11, and frequency band 412 separates audio channels 6 and 7 and spans from frequency F12 to F13. The frequency bands 402, 404, 406, 408, 410, 412 may separate the audio channels 1-7, which may help prevent audio transmissions from interfering with one another.

In certain implementations, the audio channels 1-7 may have equal bandwidths BW1-7. For example, each of the bandwidths BW1-7 may be 1 kHz wide, although other implementations may also be used (e.g., bandwidths of 500 Hz, 2 kHz, 5 kHz). In additional or alternative implementations, the audio channels 1-7 may have different bandwidth BW1-7. Additionally, in certain implementations, the frequency bands 402, 404, 406, 408, 410, 412 may be of equal width. For example, each of the frequency bands 402, 404, 406, 408, 410, 412 may be 1 kHz wide, although other implementations may also be used (e.g., frequency bands of 500 Hz, 2 kHz, 5 kHz). In further implementations, the frequency bands 402, 404, 406, 408, 410, 412 may have different widths.

In certain implementations, the bandwidths BW1-7 and frequency bands 402, 404, 406, 408, 410, 412 may have the same width. For example, the bandwidths BW1-7 and frequency bands 402, 404, 406, 408, 412 may all have a width of 1 kHz. In such instances, frequency F1 may be 9.5 kHz, frequency F2 may be 10.5 kHz, frequency F3 may be 11.5 kHz, frequency F4 may be 12.5 kHz, frequency F5 may be 13.5 kHz, frequency F6 may be 14.5 kHz, frequency F7 may be 15.5 kHz, frequency F8 may be 16.5 kHz, frequency F9 may be 17.5 kHz, frequency F10 may be 18.5 kHz, frequency F11 may be 19.5 kHz, frequency F12 may be 20.5 kHz, frequency F13 may be 21.5 kHz, and frequency F14 may be 22.5 kHz.

It should also be understood that alternative embodiments of the audio channel distribution 400 may use additional or fewer channels. For example, alternative implementations may include 10 audio channels. As another example, alternative implementations may include five or six audio channels.

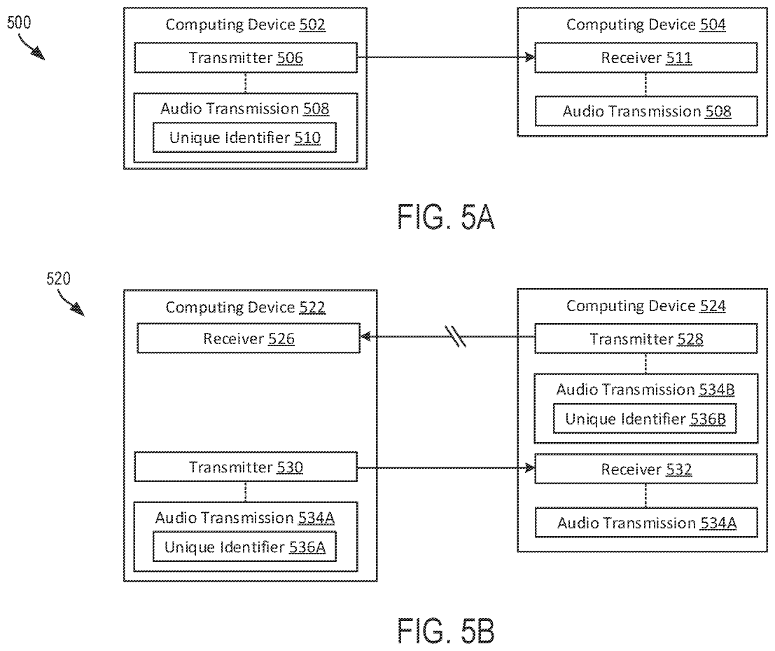

FIGS. 5A-5B illustrate audio transmission scenarios 500, 520 according to an embodiment of the present disclosure. The audio transmission scenarios 500, 520 include computing devices 502, 504, 522, 524, which may be exemplary implementations of the computing devices 102, 104, 302, 304. For example, the computing devices 502, 504, 522, 524 may be mobile devices similar to the computing devices 302, 304. In the scenarios 500, 520, the computing devices 502, 504, 522, 524 may communicate via audio transmissions. In particular, the computing devices 502, 504, 522, 524 may communicate to identify one another as matching computing devices associated with a request for a service.

In the scenario 500, the computing device 502 transmits an audio transmission 508 to the computing device 504. In particular, the computing device 502 transmits the audio transmission 508 using a transmitter 506 of the computing device 502, such as a speaker of the computing device 502. The computing device 504 receives the audio transmission 508 via a receiver 511, such as a microphone of the computing device 504. The audio transmission 508 includes a unique identifier 510. The unique identifier 510 may be uniquely associated with the computing device 502. For example, the unique identifier 510 may correspond to a request associated with the computing device 502. As a specific example, the unique identifier 510 may include one or more of a temporary, one-time passcode associated with the computing device 502, a private key associated with the computing device 502, a public key associated with the computing device 502, and/or a password hash associated with the computing device 502. In certain instances, for example, the unique identifier may be associated with a user or user account that corresponds to the computing device 502.

In the scenario 520, the computing device 522 transmits an audio transmission 534A and the computing device 524 transmits an audio transmission 534B. The audio transmission 534A contains a unique identifier 536A and the audio transmission 534B includes a unique identifier 536B. The unique identifier 536A may be associated with the computing device 522 and the unique identifier 536B may be associated with the computing device 524. The unique identifiers 536A, 536B may be implemented using techniques similar to those discussed above in connection with the unique identifier 510. For example, the unique identifier 536A may be associated with a first user that is associated with a request and the unique identifier 536B to be associated with a second user that is associated with the request. In certain implementations, the unique identifier 536A and the unique identifier 536B may be identical. The unique identifier 536A, 536B may be implemented similar to the unique identifier 510.

Both computing devices 522, 524 are depicted as transmitting the audio transmissions 534A, 534B. In certain implementations, the computing devices 522, 524 may transmit the audio transmissions 534A, 534B at different times. For example, the computing device 522 may transmit the audio transmission 534A before the computing device 524 transmits the audio transmission 534B. An additional or alternative implementations, the computing devices 522, 524 may transmit the audio transmissions 534A, 534B at the same time. For example, as discussed above, the computing devices 522, 524 may transmit the audio transmissions 534A, 550 4B at least partially at the same time using different audio channels (e.g., different audio channels 1-7 from the audio channel distribution 400).

As depicted, the audio transmission 534A is successfully received by the receiver 532 of the computing device 524. However, the audio transmission 534B is not successfully received by the receiver 526 of the computing device 522. Such failures to receive the audio transmission 534B may be due at least in part to dampening of the audio signal including the audio transmission 534B, damage to one or both of the receiver 526 and the transmitter 528, environmental interference between the computing devices 522, 524, and/or other interference with the computing devices 522, 524. For example, a user may be covering the receiver 526 on the computing device 522 and/or the transmitter 528 of the computing device 524. In such instances, the audio signal containing the audio transmission 534B may be muffled and/or dampened to the extent that the audio transmission 534B is not received by the receiver 526.

In certain instances, transmitting audio transmissions 534A, 534B with both computing device 522, 524 may be preferable to transmitting an audio transmission 508 with a single computing device 502, 504. For example, in the scenario 500, if the transmitter 506 and/or the receiver 511 are covered or otherwise interfered with, the audio transmission 508 will not be received and the unique identifier 510 cannot be verified. However, in the scenario 520, even though the audio transmission 534B is not received, the computing device 524 can still successfully receive the audio transmission 534A and verify the unique identifier 536A. As explained further below, after receiving the audio transmission 534A, the computing device 524 may therefore still be able to successfully identify the computing device 522 as corresponding to the same request. Accordingly, transmitting audio transmissions 534A, 534B using both computing devices 522, 524 may enable more robust identification of matching devices in situations where interference with receivers 511, 526, 532 and/or transmitters 506, 528, 530 of the computing devices 502, 504, 522, 524 may occur.

In certain implementations, the computing devices 502, 504, 522, 524 may be associated with a request for a particular type of service. For example, the audio transmissions 508, 534A, 534B may be transmitted to identify and/or confirm that both computing devices 502, 504, 522, 524 are associated with the same request before proceeding with fulfilling the request. The computing devices 502, 504, 522, 524 may be associated with different users, such as different parties to the request. For example, the computing devices 522, 524 may be associated with a request for transportation of a first user in the vehicle of a second user. As a specific example, the request may be for transportation using a rideshare transportation platform and/or for transportation in a medical context, such as in an emergency medical situation. In such instances, one computing device (e.g., the computing device 522) may be associated with the user requesting transportation, such as a user requesting transportation via the rideshare transportation platform and/or a user requiring emergency medical transportation. The other computing device (e.g., the computing device 524) may be associated with a user operating a vehicle associated with the request to provide transportation, such as a vehicle operated by a driver on the rideshare platform and/or an emergency medical transportation vehicle (e.g., an ambulance). In another example, the computing devices 522, 524 may be associated with a request for delivery of products (e.g., food and/or goods). As a specific example, the computing device 502 may be associated with a delivery driver picking up the products for delivery and the computing device 504 may be associated with a provider of the products (e.g., an employee at the restaurant and/or store from which the goods are being delivered). As another specific example, the computing device 502 may be associated with a delivery driver delivering products for delivery and the computing device 504 may be associated with a recipient of the products (e.g., a smart doorbell or smart phone associated with a customer). As a still further example, the computing devices 522, 524 may be associated with a request for a location-dependent service (e.g., a dog walking service). In one such example, the computing device 522 may be associated with a provider of the service (e.g., a dog walker). The computing device 524 may be associated with a recipient of the service or a location related to the service. For instance, the computing device 524 may be a computing device attached to the collar of a dog to be walked and/or may be located in the home of an owner of the dog to be walked so that the owner can confirm that the dog is walked by an authorized user (e.g., a user whose computing device is associated with the request). Based on the above examples, it should be readily apparent to one skilled in the art that the presently-discussed methods and systems may be utilized for various applications in which it may be advantageous to identify matching computing devices that are associated with requests for services. All such applications and types of services are contemplated herein.

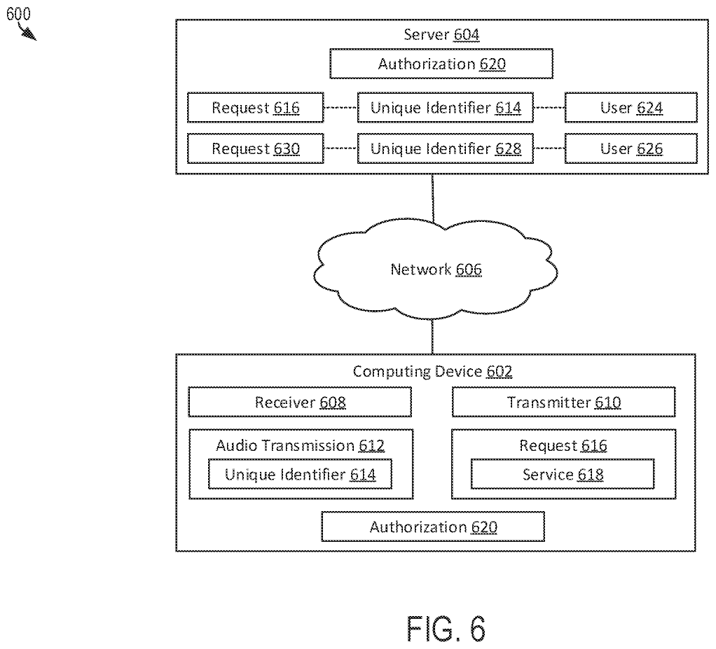

FIG. 6 illustrates a system 600 according to an exemplary embodiment of the present disclosure. The system 600 may be configured to receive and process audio transmissions identifying computing devices located near a computing device 602. For example, the system 600 may be performed to receive and process audio transmissions that are transmitted according to one of the scenarios 500, 520. The system 600 includes a computing device 602 and a server 604.

The computing device 602 may be an exemplary implementation of one of the previously-discussed computing devices 102, 104, 302, 304, 502, 504, 522, 524. The computing device 602 includes a receiver 608, which may be an exemplary implementation of the receivers 110, 112, 511, 526, 532, and a transmitter 610, which may be an exemplary implementation of the 110, 112, 506, 528, 530. The computing device 602 has received an audio transmission 612. For example, the receiver 608 of the computing device 602 may have received the audio transmission 612 from another computing device (e.g., according to one of the scenarios 500, 520). The audio transmission 612 includes a unique identifier 614. As described above, the unique identifier 614 may uniquely correspond to a computing device from which the audio transmission 612 is received. For example, the unique identifier 614 may represent a temporary identifier corresponding to the computing device from which the audio transmission 612 is received. The computing device 602 also includes a request 616. The request 616 includes a corresponding service 618. The service 618 may represent any service dependent on the correct user identifying one another and/or any location-dependent service. For example, the service 618 may include one or more of transportation of a user, delivery of food or other goods, dog walking, house cleaning and the like. The request 616 may represent a request created and/or initiated by the computing device 602. For example, the service 618 may include transportation by a rideshare platform, and the request 616 may be created using an application provided by the rideshare platform. In additional or alternative implementations, the request 616 may be created by a different computing device than the computing device 602. For example, where the service 618 is emergency medical transportation, a user may be unable to create the request 616 using the computing device 602. Accordingly, the request 616 may be created by a different computing device (e.g., a computing device associated with the emergency medical transportation provider) and may be transmitted to the computing device 602.

Upon receiving the audio transmission 612, the computing device 602 may transmit one or both of (i) the unique identifier 614 and (ii) all or part of the request 616 to the server 604. The server 604 may be configured to receive unique identifiers 614 from computing devices 602 and to determine whether the computing device 602 that received the unique identifier 614 is associated with the same request 616 is the computing device associated with the unique identifier 614. As depicted, the server 604 may store unique identifiers 614, 628 in association with requests 616, 630 and users 624, 626. For example, the server 604 may be associated with an entity that matches users requesting services to users providing services. Using the above discussed examples, the server 604 may be associated with an entity implementing a service platform, such as a transportation platform (e.g., a rideshare platform, an emergency medical transportation platform), a delivery service platform, and/or a dog walking platform. The server 604 may receive requests 616, 630 from computing devices requesting services 618 provided by the platform. For example, the requests 616, 630 may be received from computing devices associated with users 624, 626 of the platform. The received requests 616, 630 may be stored in association with the users 624, 626. The server 604 may also be configured to generate the unique identifiers 614, 628. In certain instances, the unique identifiers 614, 628 may be temporarily associated with one or both of the users 624, 626 and a request 616, 630. For example, the unique identifiers 614, 628 may be generated as a single-use passcode (e.g., a numeric passcode). The server 604 may then transmit the unique identifiers 614, 628 to the computing devices from which the requests 616, 630 are received. In certain implementations, more than one unique identifier 614, 628 may be generated for each request 616, 630. For example, as explained above, certain types of requests may have more than one associated computing device. In such instances, the server 604 may generate more than one unique identifier 614, 628 and may transmit a different unique identifier to each computing device associated with the request 616, 630. As a specific example, although not depicted, the computing device 602 may separately receive a different unique identifier from the server 604 and may transmit an audio transmission containing the different unique identifier using the transmitter 610 (e.g., similar to the scenario 520).

Upon receiving the unique identifier 614 from the computing device 602, the server 604 may verify whether the unique identifier 614 is associated with the same request 616 as the computing device 602. In certain implementations, the computing device 602 may transmit an identifier of the request 616. In additional or alternative implementations, the server 604 may receive an identifier of the computing device 602 (e.g., a user account associated with the computing device 602, an IP address of the computing device 602, a MAC address of the computing device 602). For example, the computing device 602 may be associated with a user 624 and the computing device 602 may transmit an identification of the user account with the unique identifier 614. To verify the unique identifier 614, the server 604 may compare a request associated with the computing device 602 with a unique identifier associated with the request. For example, the unique identifier 614 is associated with the request 616 and the user 624 in the server 604. Accordingly, the server 604 may determine that the unique identifier 614 is verified. Upon verifying the unique identifier 614, the server 604 may generate an authorization 620 and may transmit the authorization 620 to the computing device 602. In certain instances, the authorization 620 may indicate that further processing of the request 616 may proceed (e.g., may include an indication of the request and/or an indication that the unique identifier 614 was successfully verified). For example, where the service 618 is transportation of a user, the authorization 620 may indicate that the user has been picked up and may allow for further transportation of the user (e.g., presentation of navigation directions to the user's destination). As another example, where the service 618 includes delivery of goods, the authorization may include an indication that the goods have been picked up and are on the way to the customer.

The computing device 602 is communicatively coupled to the server 604 by the network 606. The network 606 may be implemented by one or more local networks (e.g., local area networks) and/or by one or more non-local networks (e.g., the internet). The computing device 602 and the server 604 may connect to the network 606 using one or more wired or wireless communication interfaces. For example, the computing device 602 and the server 604 may connect to the network 606 using Wi-Fi®, Ethernet, Bluetooth®, WiMAX®, and/or cellular data connections. In certain instances, the server 604 and the computing device 602 may connect to different types of networks and/or may use different types of communication interfaces.

In certain instances, the computing device 602 may only temporarily be communicatively coupled to the server 604. For example, the computing device 602 may be in an area with poor network coverage and may disconnect from the internet and the server 604 after submitting the request 616. To remedy such situations, the server 604 may provide the unique identifiers 614 to the computing devices associated with a request 616 upon receiving the request 616 and/or upon assigning a particular computing device 602 to fulfill the request. Accordingly, even if the computing device 602 disconnects from the server 604, the computing device may still retain a copy of the unique identifier 614 to transmit or to compare a received unique identifier 614 to compare to for verification.

The system 600 may therefore enable the provisioning of unique identifiers that can be transmitted locally between computing devices using audio transmissions for verification. Because the unique identifiers are transmitted using audio transmissions, proximity between computing devices associated with a request may be better ensured, as audio transmissions are less capable of data transmission over long distances. Accordingly, unique identifiers transmitted in this way may ensure both that users associated with a request are located near one another and that the correct devices and users associated with the request are matched before further processing of the request. Such techniques may therefore reduce the number of incorrectly-paired users and devices, improving the accuracy, reliability, and safety of the platforms utilized by users to receive various services.

One or both of the computing device 602 and/or the server 604 may be implemented by a computing system. For example, although not depicted one or both of the computing device 602 and the server 604 may contain a processor and a memory that implements at least one operational feature. For example, the memory may contain instructions which, when executed by the processor, cause the processor to implement at least one operational feature of the computing device 602 and/or the server 604.

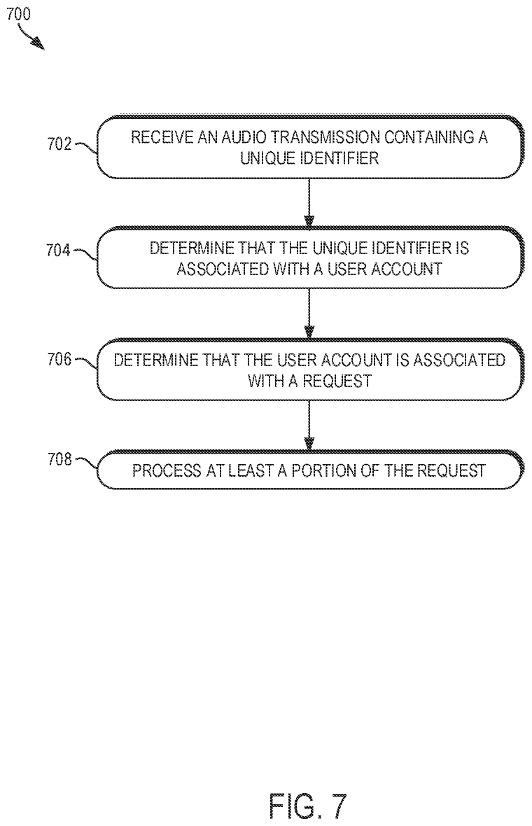

FIG. 7 illustrates a method 700 according to an exemplary embodiment of the present disclosure. The method 700 may be performed to receive and process audio transmissions from computing devices and to determine, based on the audio transmissions, whether computing devices associated with a request for service are correctly matched. The method 700 may be implemented on a computer system, such as the system 600. For example, the method 700 may be implemented by the computing device 602 and/or the server 604. Additionally or alternatively, the method 700 may be implemented at least in part by one or more of the computing devices 502, 504, 522, 524. The method 700 may also be implemented by a set of instructions stored on a computer readable medium that, when executed by a processor, cause the computer system to perform the method 700. For example, all or part of the method 700 may be implement it by a processor and a memory of the computing devices 502, 504, 522, 524, 602 and/or the server 604. Although the examples below are described with reference to the flowchart illustrated in FIG. 7, many other methods of performing the acts associated with FIG. 7 may be used. For example, the order of some of the blocks may be changed, certain blocks may be combined with other blocks, one or more of the blocks may be repeated, and some of the blocks described may be optional.

The method 700 begins with receiving an audio transmission containing a unique identifier (block 702). For example, the computing device 602 may receive an audio transmission 612 containing a unique identifier 614. The audio transmission 612 may be received from another computing device located nearby. In particular, the audio transmission 612 may be received by a receiver 608 of the computing device 602. In certain instances, receiving the audio transmission 612 may include detecting a predetermined portion of the audio transmission 612. For example, and with reference to FIG. 2, the audio transmission 612 may include a preamble 202 or other portion that contains a predetermined sequence of symbols. The computing device 602 may detect the predetermined portion (e.g., the preamble 202) and may determine, based on the detection of the predetermined portion, that an audio transmission 602 has been received. The unique identifier 614 may then be extracted from the audio transmission 612 (e.g., from a payload of 204 of the audio transmission 612).

Computing devices may be configured to transmit audio transmissions based on one or more events. For example, a computing device may be configured to transmit audio transmissions upon determining that the computing device has entered a geofence associated with the request 616 (e.g., a pickup location for a passenger and/or delivery). As another example, a computing device may receive a request from a user (e.g., via a user interface) to transmit an audio transmission containing unique identifiers. As a further example, a computing device may be configured to transmit audio transmissions after detecting a beacon signal from another computing device. In particular, a first computing device (e.g., a computing device 602 associated with an operator of a vehicle and/or a provider of a product) may transmit a beacon signal that indicates the first computing device is capable of receiving audio transmissions and is located nearby. The beacon signal may include a predetermined sequence of symbols, similar to the preamble 202 discussed above, and may indicate the capabilities of the first computing device (e.g., channels supported by the first computing device). Upon detecting the beacon signal, a second computing device may transmit an audio transmission to the first computing device (e.g., to the computing device 602).

In certain implementations, the audio transmission may be transmitted and/or received by a computing device other than a mobile device. For example, where the service 618 is transporting a passenger in a vehicle operated by a driver, the audio transmission and/or beacon signal may be transmitted by a third computing device affixed to the vehicle. As a specific example, the third computing device may include a transducer affixed to a window, body panel, or other portion of the vehicle. The transducer may be configured to vibrate such that the window, body panel, or other portion of the vehicle is caused to vibrate to transmit an audio transmission is received. Additionally or alternatively, the transducer may include a car horn of the vehicle. As another example, the third computing device may be a display or other device associated with a transportation platform that includes a transmitter and/or receiver capable of sending and receiving audio transmissions. As a still further example, where the service 618 is delivery of a product (e.g., food), the product may be stored in a locker, cubby, or other storage device that includes a computing device capable of transmitting and/or receiving audio transmissions. In still further implementations, the audio transmission 612 may be transmitted or received using receivers or transmitters that are connected to the computing device. For example, where a computing device is associated with a vehicle, the computing device may transmit audio transmissions using speakers of the vehicle.

It may then be determined that the unique identifier is associated with a user account (block 704). For example, the computing device 602 and/or the server 604 may determine that the unique identifier is associated with a user account or computing device. In particular, the computing device 602 may transmit the unique identifier 614 to a server 604 for verification. The server 604 may compare the unique identifier 614 to other unique identifiers 614, 628 stored within the server 604. The server 604 may determine that the unique identifier 614 is associated with a user 624 (e.g., a user account associated with a computing device other than the computing device 602).

It may be determined that the user account is associated with a request (block 706). For example, the server 604 may determine that the user 624 and/or a corresponding computing device is associated with a request 616. In particular, the server 604 may determine that the user 624 is associated with the same request 616 is the computing device 602 that received the audio transmission 612. For example, the computing device 602 may include an identifier of the request 616 when providing the unique identifier 614 to the server 604. Additionally or alternatively, the server 604 may identify the computing device 602 upon receiving the unique identifier 614 based on identifiers associated with the computing device 602 (e.g., a user account from which the unique identifier 614 is received, an IP address of the computing device 602, a MAC address associated with the computing device 602). The server 604 may then identify one or more requests associated with the computing device 602 (e.g., based on associations between requests and computing devices stored within the server 604). The server 604 may then compare the request associated with the computing device 602 to the request associated with the user 624 and/or the unique identifier 614. As depicted in FIG. 6, the unique identifier 614 and the user 624 are associated with the same request 616 as the computing device 602. Accordingly, the server 604 may determine that the computing device from which the audio transmission 612 is received is associated with the same request 616. In such instances, the server 604 may determine that processing of the request 616 may continue.

In certain implementations, it should be understood that one or both of blocks 704, 706 may be optional. For example, the server 604 may not identify a user account associated with the unique identifier and may instead identify a request associated with the unique identifier. Accordingly, if the unique identifier is associated with the same request as the computing device 602 that received the audio transmission at block 702, the server 604 may determine that processing of the request may continue. Additionally or alternatively, blocks 702, 704 may be performed to identify a computing device associated with the unique identifier and to determine whether the computing device is associated with a request.

At least a portion of the request may be processed (block 708). For example, the computing device 602 may process at least a portion of the request 616. In particular, the server 604 may generate an authorization 620 indicating that the unique identifier 614 is associated with the same request 616 is the computing device 602. The server 604 may transmit the authorization 620 to the computing device 602. Upon receiving the authorization 620, the computing device 602 may proceed with processing at least a portion of the request 616. In certain instances, processing the request may include presenting an alert that the request 616 may proceed. For example, where the request 616 associated with transportation of a user, the computing device 602 may present indication that the user has approached and/or entered the vehicle and may proceed with providing navigation guidance (e.g., to a driver of the vehicle). Additionally or alternatively, where the computing device 602 is associated with a passenger of the vehicle, the computing device 602 may present indication that the user has approached and/or entered the correct vehicle. In another example, where the request 616 is associated with delivery of food and/or goods, the computing device 602 may present an indication that the user's product was successfully picked up for delivery. Additionally or alternatively, the server 604 and/or the computing device 602 may store an indication that the product has been picked up and that delivery to a customer is proceeding.

In certain instances, the server 604 may transmit the authorization 620 to a computing device other than the computing device 602 that received the audio transmission 612. For example, the authorization may additionally or alternatively be transmitted to a computing device associated with a user 624 corresponding to the unique identifier 614 included within the audio transmission 612. In this way, multiple users and/or computing devices 602 may be updated regarding the progress of a request 616. As a specific example, where the request 616 is associated with a service 618 of transporting a user, the computing device 602 that received the audio transmission 612 may be associated with the user. In such instances, the server 604 may transmit the authorization 620 to both the computing device 602 associated with the user and a computing device associated with a driver of a vehicle intended to transport the user.

Performing the method 700 enables computing devices to securely and automatically determine when computing devices associated with requests for services are located near one another. Such techniques accordingly improve security for individuals receiving and/or executing requested services while also improving the speed and accuracy with which fulfillment of such requests is monitored. In particular, because audio transmissions may typically only be received between computing devices located near one another, receipt and verification of unique identifiers contained within such audio transmissions provides an immediate, automatic, and reliable indication that the correct computing devices associated with a request have been matched. The accuracy of such monitoring techniques surpasses those available using other sensors of a computing device, such as solely relying on location sensors of the computing device.

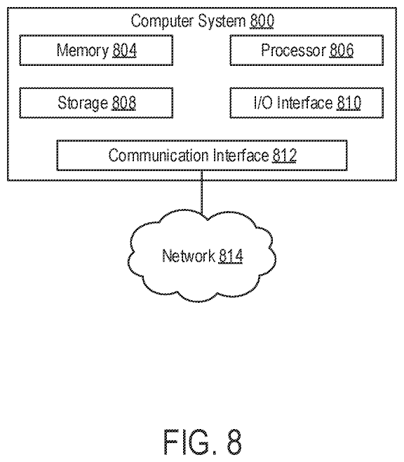

FIG. 8 illustrates an example computer system 800 that may be utilized to implement one or more of the devices and/or components discussed herein, such as the computing devices 102, 104, 302, 304, 502, 504, 522, 524, 602, and/or the server 604. In particular embodiments, one or more computer systems 800 perform one or more steps of one or more methods described or illustrated herein. In particular embodiments, one or more computer systems 800 provide the functionalities described or illustrated herein. In particular embodiments, software running on one or more computer systems 800 performs one or more steps of one or more methods described or illustrated herein or provides the functionalities described or illustrated herein. Particular embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates the computer system 800 taking any suitable physical form. As example and not by way of limitation, the computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 806, memory 804, storage 808, an input/output (I/O) interface 810, and a communication interface 812. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 806 includes hardware for executing instructions, such as those making up a computer program. As an example and not by way of limitation, to execute instructions, the processor 806 may retrieve (or fetch) the instructions from an internal register, an internal cache, memory 804, or storage 808; decode and execute the instructions; and then write one or more results to an internal register, internal cache, memory 804, or storage 808. In particular embodiments, the processor 806 may include one or more internal caches for data, instructions, or addresses. This disclosure contemplates the processor 806 including any suitable number of any suitable internal caches, where appropriate. As an example and not by way of limitation, the processor 806 may include one or more instruction caches, one or more data caches, and one or more translation lookaside buffers (TLBs). Instructions in the instruction caches may be copies of instructions in memory 804 or storage 808, and the instruction caches may speed up retrieval of those instructions by the processor 806. Data in the data caches may be copies of data in memory 804 or storage 808 that are to be operated on by computer instructions; the results of previous instructions executed by the processor 806 that are accessible to subsequent instructions or for writing to memory 804 or storage 808; or any other suitable data. The data caches may speed up read or write operations by the processor 806. The TLBs may speed up virtual-address translation for the processor 806. In particular embodiments, processor 806 may include one or more internal registers for data, instructions, or addresses. This disclosure contemplates the processor 806 including any suitable number of any suitable internal registers, where appropriate. Where appropriate, the processor 806 may include one or more arithmetic logic units (ALUs), be a multi-core processor, or include one or more processors 806. Although this disclosure describes and illustrates a particular processor, this disclosure contemplates any suitable processor.

In particular embodiments, the memory 804 includes main memory for storing instructions for the processor 806 to execute or data for processor 806 to operate on. As an example, and not by way of limitation, computer system 800 may load instructions from storage 808 or another source (such as another computer system 800) to the memory 804. The processor 806 may then load the instructions from the memory 804 to an internal register or internal cache. To execute the instructions, the processor 806 may retrieve the instructions from the internal register or internal cache and decode them. During or after execution of the instructions, the processor 806 may write one or more results (which may be intermediate or final results) to the internal register or internal cache. The processor 806 may then write one or more of those results to the memory 804. In particular embodiments, the processor 806 executes only instructions in one or more internal registers or internal caches or in memory 804 (as opposed to storage 808 or elsewhere) and operates only on data in one or more internal registers or internal caches or in memory 804 (as opposed to storage 808 or elsewhere). One or more memory buses (which may each include an address bus and a data bus) may couple the processor 806 to the memory 804. The bus may include one or more memory buses, as described in further detail below. In particular embodiments, one or more memory management units (MMUs) reside between the processor 806 and memory 804 and facilitate accesses to the memory 804 requested by the processor 806. In particular embodiments, the memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory implementations, this disclosure contemplates any suitable memory implementation.

In particular embodiments, the storage 808 includes mass storage for data or instructions. As an example and not by way of limitation, the storage 808 may include a hard disk drive (HDD), a floppy disk drive, flash memory, an optical disc, a magneto-optical disc, magnetic tape, or a Universal Serial Bus (USB) drive or a combination of two or more of these. The storage 808 may include removable or non-removable (or fixed) media, where appropriate. The storage 808 may be internal or external to computer system 800, where appropriate. In particular embodiments, the storage 808 is non-volatile, solid-state memory. In particular embodiments, the storage 808 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 808 taking any suitable physical form. The storage 808 may include one or more storage control units facilitating communication between processor 806 and storage 808, where appropriate. Where appropriate, the storage 808 may include one or more storages 808. Although this disclosure describes and illustrates particular storage, this disclosure contemplates any suitable storage.

In particular embodiments, the I/O Interface 810 includes hardware, software, or both, providing one or more interfaces for communication between computer system 800 and one or more I/O devices. The computer system 800 may include one or more of these I/O devices, where appropriate. One or more of these I/O devices may enable communication between a person (i.e., a user) and computer system 800. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 810 may include one or more device or software drivers enabling processor 806 to drive one or more of these I/O devices. The I/O interface 810 may include one or more I/O interfaces 810, where appropriate. Although this disclosure describes and illustrates a particular I/O interface, this disclosure contemplates any suitable I/O interface or combination of I/O interfaces.

In particular embodiments, communication interface 812 includes hardware, software, or both providing one or more interfaces for communication (such as, for example, packet-based communication) between computer system 800 and one or more other computer systems 800 or one or more networks 814. As an example and not by way of limitation, communication interface 812 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 814 and any suitable communication interface 812 for the network 814. As an example and not by way of limitation, the network 814 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 812 for any of these networks, where appropriate. Communication interface 812 may include one or more communication interfaces 812, where appropriate. Although this disclosure describes and illustrates a particular communication interface implementations, this disclosure contemplates any suitable communication interface implementation.

The computer system 802 may also include a bus. The bus may include hardware, software, or both and may communicatively couple the components of the computer system 800 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving, from a first computing device, a first audio transmission containing a first unique identifier;
determining that the first unique identifier is associated with the first computing device;
determining that the first computing device is associated with a request; and
processing at least a portion of the first request.

2. The method of claim 1, wherein the first audio transmission is received at a second computing device.

3. The method of claim 2, wherein the method further comprises, prior to receiving the first audio transmission, transmitting, from the second computing device, a second audio transmission containing a second unique identifier.

4. The method of claim 3, wherein the first computing device and the second computing device are configured to respectively transmit the first audio transmission and the second audio transmission at least partially at the same time.

5. The method of claim 3, wherein the first audio transmission is transmitted on a first audio channel and the second audio transmission is transmitted on a second audio channel different from the first audio channel.

6. The method of claim 3, wherein the first request is associated with transportation of a user using a vehicle, and wherein at least one (i) the first computing device is associated with the user and the second computing device is associated with an operator of the vehicle and (ii) the first computing device is associated with the operator of the vehicle and the second computing device is associated with the user.

7. The method of claim 6, wherein at least one of the first audio transmission and the second audio transmission is transmitted using speakers of the vehicle.

8. The method of claim 6, wherein at least one of the first audio transmission and the second audio transmission is transmitted using a transducer affixed to at least a portion of the vehicle.

9. The method of claim 6, wherein at least one of the first audio transmission and the second audio transmission is transmitted using a horn of the vehicle.

10. The method of claim 2, wherein the first request is associated with delivery of a product using a vehicle, and wherein at least one of (i) the first computing device is associated with a provider of the product and the second computing device is associated with an operator of the vehicle and (ii) the first computing device is associated with the operator of the vehicle and the second computing device is associated with the provider of the product.

11. The method of claim 2, wherein the first computing device transmits the first audio transmission in response to at least one of (i) detecting that a location of the first computing entered a geofence associated with the first request, (ii) detecting an audio signal transmitted by the second computing device, and (iii) detecting an audio signal transmitted by a third computing device associated with the first request.

12. The method of claim 1, wherein receiving the first audio transmission further comprises:
detecting a predetermined portion of the audio transmission; and
extracting the first unique identifier from the audio transmission.

13. The method of claim 1, wherein the first unique identifier is a single-use identifier temporarily associated with the first computing device.

14. The method of claim 1, wherein determining that the unique identifier is associated with the first computing device includes determining that the unique identifier is associated with a user account corresponding to the first computing device.

15. A system comprising:
a processor; and
a memory storing instructions which, when executed by the processor, cause the processor to:
receive, from a first computing device, a first audio transmission containing a first unique identifier;
determine that the first unique identifier is associated with the first computing device;
determine that the first computing device is associated with a request; and
process at least a portion of the first request.

16. The system of claim 15, wherein the first audio transmission is received at a second computing device containing the processor and the memory.

17. The system of claim 16, wherein the memory stores further instructions which, when executed by the processor prior to receiving the first audio transmission, cause the processor to transmit, from the second computing device, a second audio transmission containing a second unique identifier.

18. The system of claim 17, wherein the first computing device and the second computing device are configured to respectively transmit the first audio transmission and the second audio transmission at least partially at the same time.

19. The system of claim 17, wherein the first request is associated with transportation of a user using a vehicle, and wherein at least one (i) the first computing device is associated with the user and the second computing device is associated with an operator of the vehicle and (ii) the first computing device is associated with the operator of the vehicle and the second computing device is associated with the user.

20. The system of claim 16, wherein the first request is associated with delivery of a product using a vehicle, and wherein at least one of (i) the first computing device is associated with a provider of the product and the second computing device is associated with an operator of the vehicle and (ii) the first computing device is associated with the operator of the vehicle and the second computing device is associated with the provider of the product.

21. The system of claim 16, wherein the first computing device transmits the first audio transmission in response to at least one of (i) detecting that a location of the first computing entered a geofence associated with the first request, (ii) detecting an audio signal transmitted by the second computing device, and (iii) detecting an audio signal transmitted by a third computing device associated with the first request.
